(19) United States
(12) Patent Application Publication
(10) Pub. No.: US 2011/0168033 A1
(43) Pub. Date: Jul. 14, 2011

(54) BODY ARRANGEMENT ASSOCIATED WITH AT LEAST ONE DIRECT-BROILING COOKER

(75) Inventor: Hyun Sam Lee, Busan (KR)

(73) Assignee: HAPPYCALL CO., LTD., Gyeongsangnam-do (KR)

(21) Appl. No.: 12/769,739

(22) Filed: Apr. 29, 2010

(30) Foreign Application Priority Data
Jan. 14, 2010 (KR) 10-2010-0003417
Feb. 25, 2010 (KR) 10-2010-0016946

(51) Int. Cl. A47J 37/07

(52) U.S. Cl. 99/446

(57) ABSTRACT

A body for at least one direct-broiling cooker, which is configured to suppress heat transfer to a drip channel, thus performing cooking function(s), without requiring water to be contained in the drip channel.

### CROSS-REFERENCE TO RELATED APPLICATION(S)

This application claims priority from Korean Patent Application No. 10-2010-0003417 filed on Jan. 14, 2010, and Korean Patent Application No. 10-2010-0016946 filed Feb. 25, 2010, both under 35 U.S.C. §119. The disclosures of the above-referenced applications are incorporated herein by reference in their entities.

### FIELD OF PRESENT DISCLOSURE

The present disclosure relates to exemplary embodiments of a body associated with at least one direct-broiling cooker, which can suppress heat transfer to a drip channel, thus executing cooking without requiring water to be contained in the drip channel.

### BACKGROUND INFORMATION

An example of conventional direct-broiling cookers is described in Korean Patent No. 10-0907608. As shown in FIGS. 1 and 2, the direct-broiling cooker described in the Korean Patent No. 10-0907608 includes a drip pan 10 having a flame guide opening 11 and a shallow drip channel 12 formed around the flame guide opening 11, a broiling plate 20 put on the drip pan 10 and having a heat inlet hole 21 for receiving flames from the flame guide opening 11, a dome lid 30 for covering the broiling plate 20, and a reflector 40 mounted to the ceiling of the lid 30. In the broiling plate 20 of this cooker, oil drip holes 22 are formed and evenly arranged in radial directions so that the oil drip holes 22 can drip liquid waste into the shallow drip channel 12 of the drip pan 10. An outer wall of the drip pan 10 is provided with circulation holes 13. Further, subsidiary flame guide holes 14 are formed around the flame guide opening 11 of the drip pan 10.

Prior to starting cooking, a predetermined amount of water is contained in the shallow drip channel 12 for the purpose of making the oil drip from the broiling plate 10 into the water, instead of directly dripping onto the hot shallow drip channel 12, thus preventing smoke from being generated as a result of oil dripping onto the hot channel 12.

However, during cooking, the water contained in the shallow drip channel 12 vaporizes and soaks into the food, so that the cooker may not prepare delicious broiled food, such as delicious barbecue. Further, when the direct-broiling cooker leans to one side or falls during cooking, the water and oil contained in the drip channel may be spilt through the circulation holes 13, thus possibly burning persons surrounding the cooker or soiling the surroundings.

Thus, there may be a need to overcome at least such issues associated with these conventional direct-broiling cookers.

### SUMMARY OF EXEMPLARY EMBODIMENTS OF THE DISCLOSURE

Accordingly, certain exemplary embodiments of the present disclosure can be provided to address at least some of the above-described problems provided in the art.

Thus, exemplary embodiments of the present disclosure can be provided which can include a body for direct-broiling cookers, which can reduce or prevent smoke from being generated as a result of oil dripping onto a hot drip channel without the need to have the water to be contained in the drip channel, and to prevent or reduce the moisture from soaking into food, thus enhancing the taste of broiled food.

In one exemplary embodiment of the present disclosure, a body can be provided for direct-broiling cookers, which can comprise an inner wall defining a flame guide opening therein. The body can also include an outer wall surrounding the inner wall, a bottom portion extending between the inner wall and the outer wall and forming a drip channel, and a flame guide provided between the inner wall and the flame guide opening. For example, air can be guided between the inner wall and the flame guide, and flames can be guided to a center of the flame guide.

In the above-described exemplary body, air currents can flow along the inner wall, so that the air currents can intercept heat of the flames, thus suppressing or reducing the heat transfer to the drip channel. Even when heat is transferred to the inner wall or to the bottom in this exemplary embodiment of the present disclosure, the air currents can cool the inner wall and the bottom, thus preventing or reducing the generation of smoke as a result of oil dripping onto the bottom without requiring water to be contained in the drip channel. Further, the body does not generate moisture or reduces the generation of moisture, thus preventing or reducing moisture from soaking into the food, and providing a better tasting broiled food to be prepared using a conventional gas burner.

According to another exemplary embodiment of the present disclosure, the bottom may be an inclined bottom which can be inclined downwards in a direction from the inner wall to the outer wall. In the body having the inclined bottom, the dripping oil can be guided to the outer wall relatively remote from the flames, thus, e.g., almost completely preventing or significantly reducing the smoke from being generated as a result of the oil dripping onto the bottom.

In still another exemplary embodiment of the present disclosure, the flame guide can be mounted to a safety stand frame removably installed in an inlet of the flame guide opening. The above-described body can be stably and safely utilized on the support legs of a burner of any size diameter without slipping off or to the side.

According to yet another exemplary embodiment of the present disclosure, the safety stand frame can comprise a hollow base plate holding the flame guide, an antislip part provided in a lower surface of the base plate; and inner fitting pieces provided on the base plate and fitted into the flame guide opening, thus supporting the inner wall. Due to the above-described exemplary safety stand frame, the body can be stably supported on support legs of a burner without slipping, as the antislip part can be laid on the support legs.

In a further exemplary embodiment of the present disclosure, the inner wall can be provided with two rows of subsidiary flame guide holes, where a first row of subsidiary flame guide holes and a second row of subsidiary flame guide holes can arranged in a zigzag arrangement/manner. The two rows of subsidiary flame guide holes can lengthen the heat transfer distance, so that, when heat is transferred to the inner wall of the drip channel through the flame guide opening, the heat transfer is retarded.

In an additional exemplary embodiment of the present disclosure, the flame guide can be supported at an upper end thereof by the inner wall, and can be provided at a lower end thereof with an antislip part placed at a location lower than the lower surface of the bottom.

In the body of a particular exemplary embodiment of the present disclosure, the flame guide can be installed or provided between the inner wall and the flame guide opening, thus guiding air currents through a path defined between the inner wall and the flame guide and guiding flames through the center of the flame guide. Therefore, the air currents can intercept heat of the flames, thus possibly suppressing the heat transfer to the drip channel. Even when heat is transferred to the inner wall or to the bottom, the air currents can cool the inner wall and the bottom, thus preventing or reducing the smoke from being generated as a result of oil dripping onto the bottom without requiring water to be contained in the drip channel. Further, the body does not generate moisture, thus preventing or reducing moisture from soaking into food and allowing delicious broiled food to be prepared using a conventional gas burner.

Further, according to still a further exemplary embodiment, the bottom can be an inclined bottom which can be inclined downwards in the direction from the inner wall to the outer wall, so that dripping oil is guided to the outer wall relatively remote from the flames, thus almost completely preventing smoke from being generated as a result of the oil dripping onto the bottom. Additionally, the flame guide can be mounted to the safety stand frame which is removably installed in the inlet of the flame guide opening, so that the body can be stably and safely used on support legs of a burner of any size in diameter without slipping over.

Further, the inner wall is provided with two rows of subsidiary flame guide holes, wherein the first row of subsidiary flame guide holes and the second row of subsidiary flame guide holes are arranged in a zigzag arrangement. The two rows of subsidiary flame guide holes lengthen the heat transfer distance, so that, when heat is transferred to the inner wall of the drip channel through the flame guide opening, heat transfer is retarded.

These and other objects, features and advantages of the exemplary embodiment of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying figures showing illustrative embodiments of the present disclosure, in which:

FIG. 1 is an exploded perspective view illustrating a conventional direct-broiling cooker in an unassembled configuration;

FIG. 2 is a perspective view illustrating a direct-broiling plate of the conventional direct-broiling cooker of FIG. 1, in which a broiling plate is provided on a body of the cooker, and a lid is opened;

FIGS. 3 and 4 are top perspective views illustrating a direct-broiling cooker according to an exemplary embodiment of the present disclosure in a disassembled state and an assembled state, respectively;

FIGS. 5 and 6 are bottom perspective views of the direct-broiling cooker according to the exemplary embodiment of the present disclosure shown in FIGS. 3 and 4, in the disassembled state and the assembled state, respectively;

FIG. 7 is a side sectional view of the exemplary direct-broiling cooker taken along line 7-7 of FIG. 4;

FIG. 8 is a bottom perspective view of a hood of the direct-broiling cooker of the FIG. 3;

FIG. 9 is a top perspective view of the hood of the direct-broiling cooker according to another embodiment of the present disclosure;

FIG. 10 is a side sectional view of the exemplary hood of FIG. 9 fitted over a collar of a broiling plate in accordance with the exemplary embodiment of the present disclosure;

FIG. 11 is a side view of the direct-broiling cooker of an exemplary embodiment according to the present disclosure shown in FIGS. 3-6 provided on a burner using a safety stand frame;

FIG. 12 is an exploded perspective view of a direct-broiling cooker according to yet another exemplary embodiment of the present disclosure;

FIGS. 13A and 13B are top and bottom perspective views of a body of the direct-broiling cooker shown in FIG. 12, respectively;

FIG. 14 is a side sectional view of the direct-broiling cooker taken along line 14-14 of FIG. 13A; and

FIGS. 15 and 16 are bottom perspective views illustrating the bodies of the direct-broiling cooker according to further embodiments of the present disclosure.

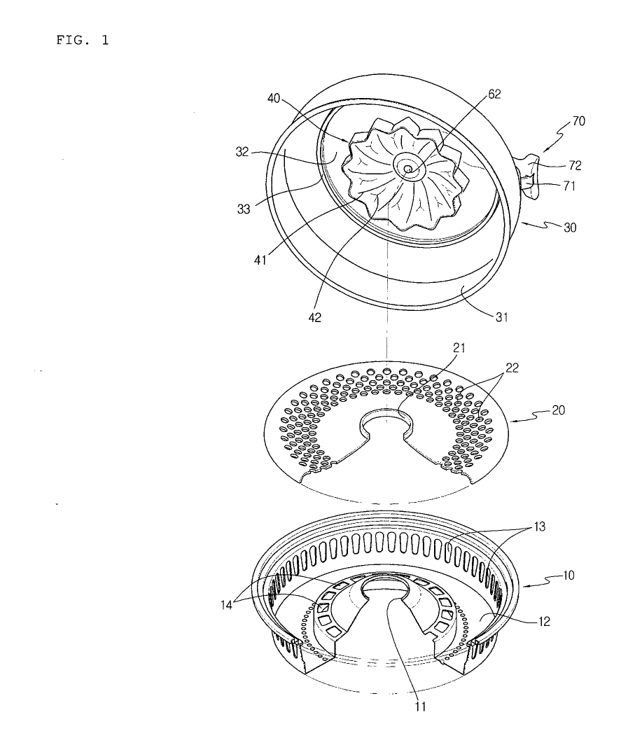

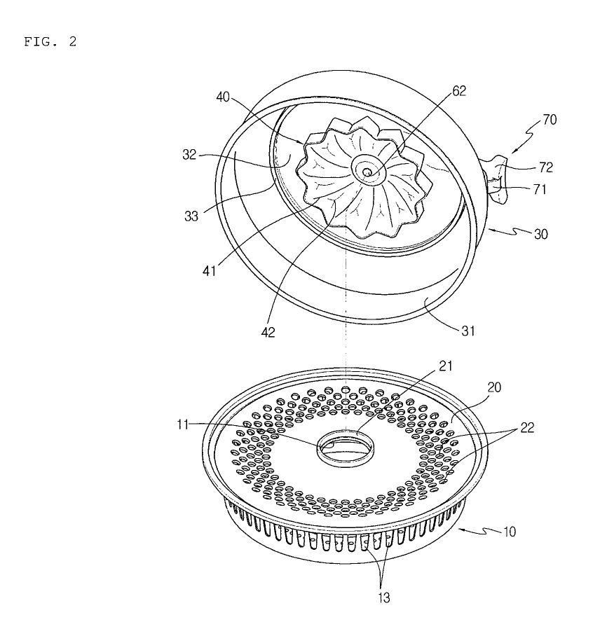

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described exemplary embodiments without departing from the true scope and spirit of the subject disclosure as defined by the appended claims.

### DETAILED DESCRIPTION OF EXEMPLARY EMBODIMENTS

Herein below, direct-broiling cookers according to certain exemplary embodiments of the present disclosure are be described in detail with reference to the accompanying drawings. In the following description, those elements common to both the conventional embodiments and the exemplary embodiments of the present disclosure provide the same reference numerals, and further explanation can be omitted.

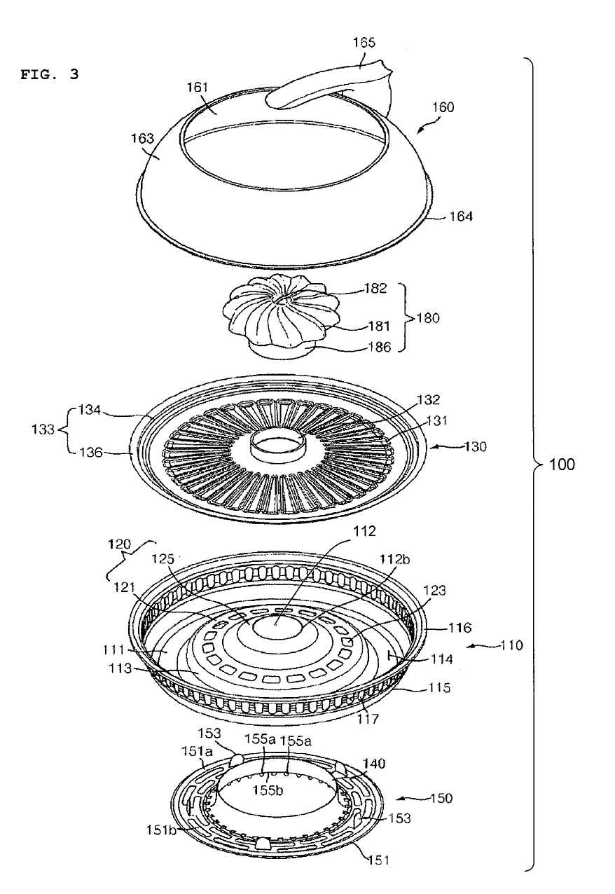

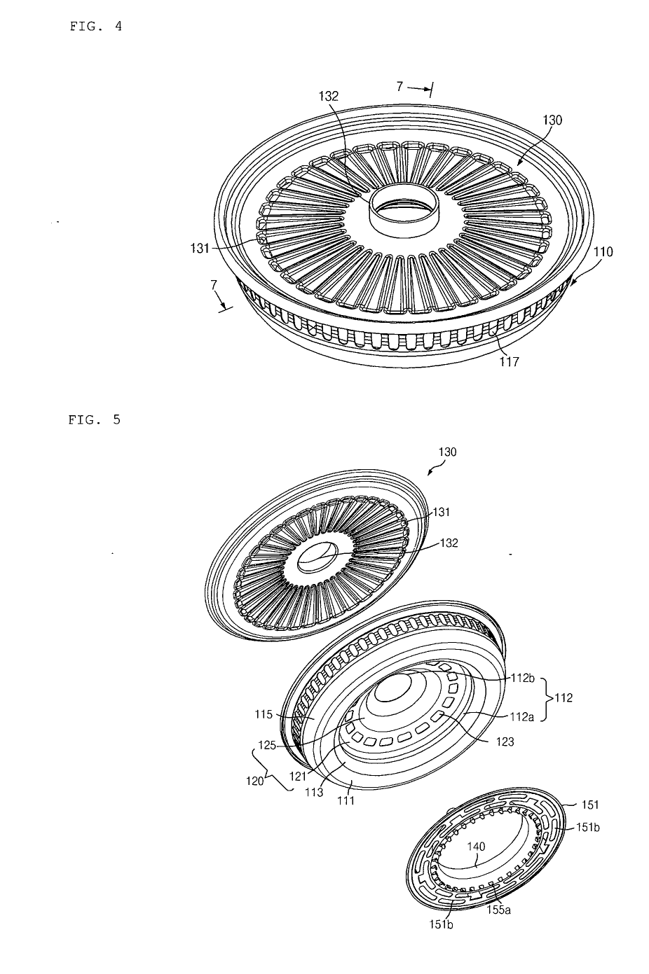

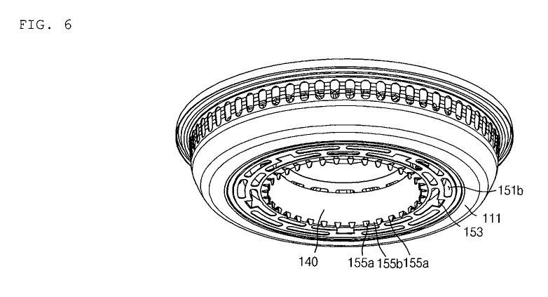

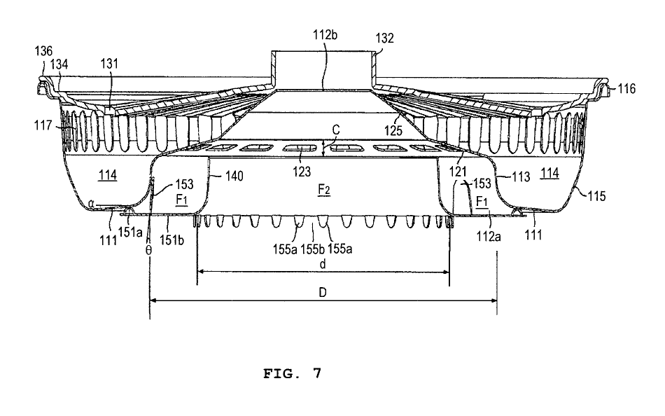

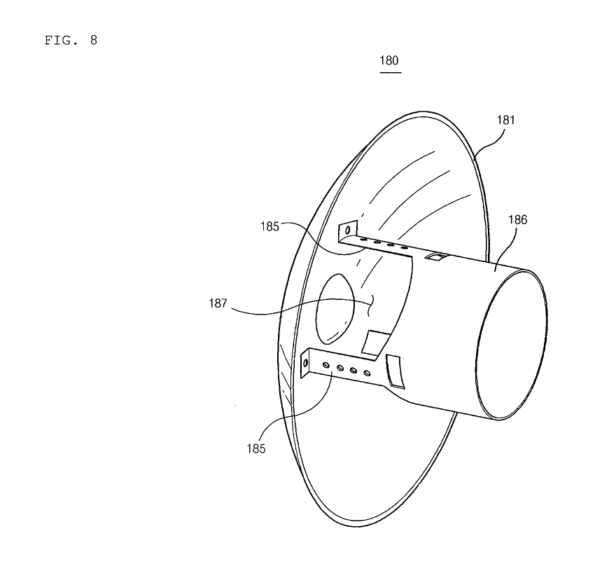

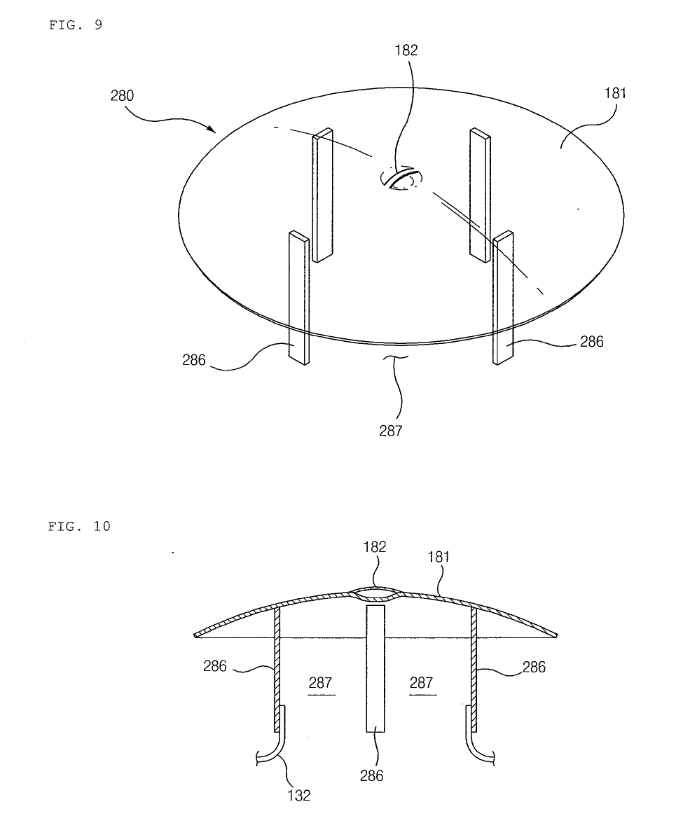

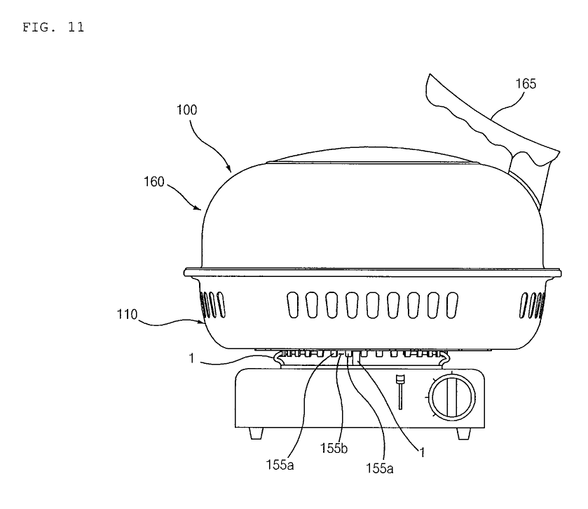

FIGS. 3 and 4 show top perspective views illustrating a direct-broiling cooker according to an exemplary embodiment of the present disclosure in a disassembled state and an assembled state, respectively. FIGS. 5 and 6 show bottom perspective views of the direct-broiling cooker of FIGS. 3 and 4 according to the exemplary embodiment of the present disclosure in the disassembled state and the assembled state, respectively. FIG. 7 shows a side sectional view of the direct-broiling cooker taken along line 7-7 of FIG. 4. FIG. 8 shows a bottom perspective view of the hood of the direct-broiling cooker illustrated in FIG. 3. FIG. 9 is a top perspective view of a hood according to another embodiment of the present disclosure. FIG. 10 shows a sectional view illustrating the hood of FIG. 9 fitted over a collar of a broiling plate. FIG. 11 shows a side view illustrating the direct-broiling cooker of the present disclosure illustrated in FIGS. 3-6. provided on a burner using a safety stand frame.

As shown in FIGS. 3 through 9, the direct-broiling cooker 100 according to the first exemplary embodiment of the present disclosure includes a body 110 which can have a flame guide opening or path 112, a broiling plate 130 sitting on the body 110, a heat inlet hole 132, and a lid 160 for covering the broiling plate 130. The direct-broiling cooker 100 according to this exemplary embodiment can further include a heat guide 120 forming a heat path from the flame guide opening 112 to the heat inlet hole 132, and a hood 180 arranged on the heat inlet hole 132.

The body 110 of this exemplary embodiment can comprise a bottom portion 111, an outer wall 115 extending upwards from the bottom portion 111, and an inner wall 113 extending upwards in the central area of the bottom portion 111 such that the inner wall 113 defines the flame guide opening 112 therein. The flame guide opening or path 112 can form a heat path comprising an inlet-side flame guide opening 112a and an outlet-side flame guide opening 112b. The inlet-side flame guide opening 112a is almost leveled with the bottom portion 111, and the outlet-side flame guide opening 112b is defined at a location closer to the heat inlet hole 132.

A drip channel 114 can be provided between the inner wall 113 and the outer wall 115 for collecting oil.

In the body 110, the height of the inner wall 113 can be lower than the height of the outer wall 115. The outer wall 115 can include circulation holes 117, which form an air circulation path along with oil drip holes 131 which will be described later herein. Due to the air circulation path formed by both the circulation holes 117 and the oil drip holes 131, air can circulate between the atmosphere and the chamber defined between the broiling plate 130 and the lid 160. The broiling plate 130 can have the heat inlet hole 132 at the center thereof. The heat inlet hole 132 can introduce heat from the flame guide opening 112 into the chamber defined between the broiling plate 130 and the lid 160.

The oil drip holes 131 can be formed through the broiling plate 130 at locations between the heat inlet hole 132 and the outer edge of the broiling plate 130, and can function to drip liquid waste, such as oil, onto the drip channel 114. Food to be cooked can be provided on the perforated broiling plate 130 having the oil drip holes 131. Further, the outer edge of the broiling plate 130 can be finished by a rolled edge 133, which has both a lid seat 134 for seating a lower edge 164 of the lid 160 thereon and a sitting rim 136 for sitting on an upper rim 116 of the outer wall 115 of the body 110.

The lower edge 164 of the lid 160 can be seated on the lid seat 134 of the broiling plate 130 and the sitting rim 136 of the broiling plate 130 is put on the upper rim 116 of the body 110, so that dispersed oil drops cannot leak from the chamber defined between the broiling plate 130 and the lid 160 to the body 110. Thus, the direct-broiling cooker 100 can facilitate an environment which is beneficial for cooking. In particular, the exemplary embodiment of the direct-broiling cooker 100 according to the present disclosure can prevent or reduce dispersed oil drops dripping onto the hot body 110, and generating unwanted smoke.

The lid 160 can comprise a dome lid body 163 and a handle 165 mounted to the lid body 163. The center of the lid body 163 can include a transparent heat resistant tempered glass window 161 which can facilitate a user to cook food while viewing the state of cooking of the food.

In this exemplary embodiment, the direct-broiling cooker 100 can further include a hood 180 for evenly distributing heat into the chamber defined between the broiling plate 130 and the lid 160 and for preventing the dispersed oil drops from dripping into the heat inlet hole 132. The hood 180 can comprise a dome canopy 181 and a hollow pipe 186 extending between the heat inlet hole 132 and the canopy 181. The hollow pipe 186 can have a tubular shape, which can have a circular cross-section and is thoroughly hollowed in a longitudinal direction. The canopy 181 can directly guide flames from the hollow pipe 186 to food on the broiling plate 130, thus realizing a flame spraying effect and increasing the direct-broiling effect.

Further, the canopy 181 can also function as a cover for covering heat outlet holes 187, which can be formed through the sidewall of the hollow pipe 186 or between the hollow pipe 186 and the canopy 181, so that flames from the heat inlet hole 132 can flow upwards through the hollow pipe 186 prior to being distributed onto the entire area, of the upper surface of the broiling plate 130 through the heat outlet holes 187. Indeed, the dispersed oil drops can be prevented or reduced from dripping into the flame guide opening 112 through the heat outlet holes 187 due to the dome canopy 181, which can realize an umbrella effect. Due to the hood 180, the direct-broiling cooker 100 of the exemplary embodiment according to the present disclosure can directly distribute flames to the food provided on the broiling plate 130, and can prevent or reduce the dispersed oil drops from dripping into the flame guide opening 112.

Further, the hood 180 can be installed in the direct-broiling cooker 100 by fitting the lower end of the hollow pipe 186 over a collar of the broiling plate 130, which defines the heat inlet hole 132 therein. Further, the canopy 181 can be supported by the hollow pipe 186, so that the inner surface of the lid 160 has a structure suitable for easy washing thereof. Further, the hollow pipe 186 increases the height of the canopy 181, is structured to evenly distribute heat over the food, and functions as a chimney increasing the flame inlet speed in cooperation with a flame guide 140 which as shall be described herein.

As shown in FIG. 8, to form the heat outlet holes 187, mounting arms 185 can be provided between the canopy 181 and the hollow pipe 186, and the spaces defined between the mounting arms 185 function as the heat outlet holes. In this exemplary embodiment, to provide the heat outlet holes 187, the upper end of the hollow pipe 186 can be longitudinally cut to form slits. It should be understood that the heat outlet holes 187 can be formed by perforating the sidewall of the hollow pipe 186. The integration of the canopy 181 with the mounting arms 185 of the hollow pipe 186 can be effectuated through welding, screwing, bracketing or in numerous other ways, as is well known to those having ordinary skill in the art.

According to another exemplary embodiment of the present disclosure shown in FIG. 9 and FIG. 10, a hood 280 can be provided having rod-shaped spacers 286, instead of the hollow pipe 186. For example, at least two rod-shaped spacers 286, which can be mounted at their upper ends to the lower surface of the canopy 181 by a welding procedure or another locking procedure, may be fitted at their lower ends over the collar so as to define the heat inlet hole 132. When the hood 280 having the rod-shaped spacers 286 is used, dispersed oil drops likely drip into the heat inlet hole 132 due to the low collar of the heat inlet hole 132.

To prevent or reduce the dispersed oil drops from dripping into the heat inlet hole 132 in such case, the collar of the heat inlet hole 132 can be raised to a level that is not lower than the height of the sitting rim 136 of the broiling plate 130. When the hood 280 having the rod-shaped spacers 286 is used, the gaps 287 defined between the spacers 286 function as the heat outlet holes. Further, the upper surface of the canopy 181 can include a hooking rib 182. When it is required to move the hot hood 180 or 280 after cooking, a user can safely move the hot hood using a safety hook which can hook or be attached to the hooking rib 182, thus preventing the fingers of the user from being burnt.

In this exemplary embodiment, the heat guide 120 can be integrated with the body 110, and can integrally extend from the inner wall 113 of the body 110. Such integration of the heat guide 120 with the body 110 can be advantageous in that it does not require an additional structure for locking the heat guide 120 to another element, and realizes a simple structure of the broiling plate 130, thus facilitating a user to easily wash the broiling plate 130. Further, the heat guide 120 can comprise a first heat guide 121 and a second heat guide 125, which incline toward each other. Further, an upper end of the second heat guide 125 can functions as or together with the outlet-side flame guide opening 112b.

The diameter of the heat inlet hole 132 of the broiling plate 130 can be inversely proportional to a surface area of the other part of the broiling plate 130 on which food can be provided. Thus, to increase the surface of the broiling plate 130 on which food can be placed, the diameter of the heat inlet hole 132 can be reduced.

When the heat guide 120 is configured to form a convergent shape, flames likely flow in through the larger inlet-side flame guide opening 112a and then into the smaller heat inlet hole 132 through the outlet-side flame guide opening 112b, so that the cooker can realize the desired heat efficiency and the desired cooking efficiency at the same time. Further, in the body 110, the bottom portion 111 can have a predetermined surface area. In this exemplary embodiment, the predetermined surface area of the bottom portion 111 can be secured by reducing the diameter of the flame guide opening 112.

Therefore, to reduce or avoid energy loss due to the flame guide opening 112 having the reduced diameter, subsidiary flame guide holes 123 can be provided in the body 110. When the flames from the burner flow into the flame guide opening 112, such flames can flow through the heat guide 120 and through the subsidiary flame guide holes 123, thus addressing energy loss issue of the cooker 100.

In this exemplary embodiment of the present disclosure, the flame guide 140 can be placed between the flame guide opening 112 and the inner wall 113. Due to the positioning of the flame guide 140 with respect to the body 110, the flame guide opening 112 can be partitioned into two heat paths. For example, as shown in FIG. 7, a first heat path F1 can be defined between the inner wall 113 and the flame guide 140, and can guide air currents, while a second heat path F2 can be defined in the center of the flame guide 140 and can guide the flames. To form both the first heat path F1 and the second heat path F2, a chimney type pipe can be used as the flame guide 140.

Due to the flame guide 140 having the above-described exemplary structure, air currents can flow along the inner surface of the inner wall 113, thus likely reducing or suppressing the heat transfer to the drip channel 114, and maintaining the drip channel 14 at a moderate temperature at which oil dripping into the channel 14. This exemplary configuration promotes the reduction or non-generation of smoke, and effectuates a reduction of oil from being stuck to the drip channel 14. Therefore, the body 110 can be used for cooking without requiring water to be contained in the drip channel 114.

Further, as shown in FIG. 7, the flame guide 140 can be arranged such that the upper end of the guide 140 converges to the first heat guide 121 with a gap C formed between the upper end of the flame guide 140 and the first heat guide 121. In the gap C, air currents meet flames. When the air currents meet the flames, the air currents having a lower temperature draw the flames having a higher temperature upwards, thus increasing a chimney effect of the flame guide 140, and increasing the flame inlet speed into the body 110. Due to the increase in the flame inlet speed into the body 110, the cooker 100 can realize a high heat efficiency and can prepare better tasting broiled food.

Further, the upper end of the flame guide 140 can be arranged around the junction between the first heat guide 121 and the second heat guide 125, so that the upper end of the flame guide 140 does not obstruct the subsidiary flame guide holes 123. The flame guide 140 can be mounted to a safety stand frame 150, which can be removably attached to the flame guide opening 112, or can be mounted to the body 110 by welding as shall be described herein. The detachable safety stand frame 150 can comprise a hollow base plate 151, inner fitting pieces 153 provided on the upper surface of the base plate 151, and an antislip part 155 provided in the lower surface of the base plate 151.

The flame guide 140 can be provided in the central opening of the base plate 151 and forms the first heat path Fl through which flames pass. The inner fitting pieces 153 can be fitted into the flame guide opening 112 of the inner wall 113, thus holding the location of the safety stand frame 150 relative to the inner wall 113. Further, the upper surface of the base plate 151 can be provided along the outer edge with an annular support ridge 151a for supporting the bottom portion 111 of the body 110 thereon. The annular support ridge 151a can be in linear contact instead of surface contact with the bottom portion 111, so that the base plate 151 can be prevented from being stuck to the bottom portion 111.

Further, the base plate 151 can be provided with through holes 151b forming the second heat path F2. In another exemplary embodiment, ribs instead of the through holes 151b can be formed in the base plate 151 such that the ribs can extend to the flame guide 140 and form spaces for the second heat path F2. The inner fitting pieces 153 can prevent the body 110 from moving in a diametrical direction of the bottom portion 111, while the antislip part 155 can prevent the safety stand frame 150 from moving on support legs 1 of the burner 100. The inner fitting pieces 153 can be integrated with the base plate 151 in an L-shaped cross-section, thus stably supporting the body 110. The inner fitting pieces 153 can slightly lean outwards at a leaning angle θ relative to the annular body 151. Due to the leaning angle θ, e.g., only the upper ends of the inner fitting pieces 153 come into linear contact with the inner wall 113 of the flame guide opening 112 without being strongly fitted into the inner wall 113, so that the safety stand frame 150 can be easily removed from the body 110.

Further, the antislip part 155 can comprises saw-toothed antislip protrusions 155a and antislip notches 155b defined between the antislip protrusions 155a and engaging with the support legs 1 of the burner 100. When the antislip notches 155 stably engage with the support legs 1, the body 110 can be prevented from slipping over the burner 100. The respective antislip protrusions 155a can be bent through pressing to form a curled cantilever structure.

As described herein, the safety stand frame 150 can be configured or structured to be removably attached to the flame guide opening 112 of the body 110, so that the body 110 can be used with or without the safety stand frame 150 according to the structure of the support legs 1. Further, the detachable safety stand frame 150 can be easily washed and conveniently stored when not used.

The inner diameter d of the flame guide 140 of the safety stand frame 150 laid on the support legs 1 can be smaller than the inner diameter D of the inlet-side flame guide opening 112a, so that the safety stand frame 150 can be well-adapted to the diameter size of support legs 1 according to cooking styles or to the force of the fire. Thus, the body 110 assembled with the safety stand frame 150 can be stably and safely used on a burner.

The hollow base plate 151 can have an annular shape according to this exemplary embodiment. However, it should be understood that the hollow base plate 151 can have a hollow polygonal shape, such as a triangular or square shape, as well as other shapes, without affecting the functionality of the exemplary embodiment of the present disclosure.

As described above, the body 110 of the present disclosure can be used without requiring water to be contained in the drip channel 114. According to another exemplary embodiment, to completely prevent the generation of smoke as a result of oil dripping onto the drip channel 114, it is possible for the bottom portion 111 of the drip channel 114 to be inclined downwards in a direction from the inner wall 113 to the outer wall 115 at an angle α of inclination. When the oil drips onto the inclined bottom portion 111 and is dispersed, the bottom portion 111 can guide the dispersed oil toward the outer wall 115 instead of the inner wall 113 having a higher temperature than that of the outer wall 115, due to the inclination angle α. Thus, according to a particular exemplary embodiment of the present disclosure, the body 110 can completely prevent the generation of smoke as a result of oil dripping onto the drip channel 114. The outer wall 115 can be remote from the flames and always comes into contact with atmospheric air outside the wall 115, thus completely preventing the generation of oil smoke as a result of oil burning.

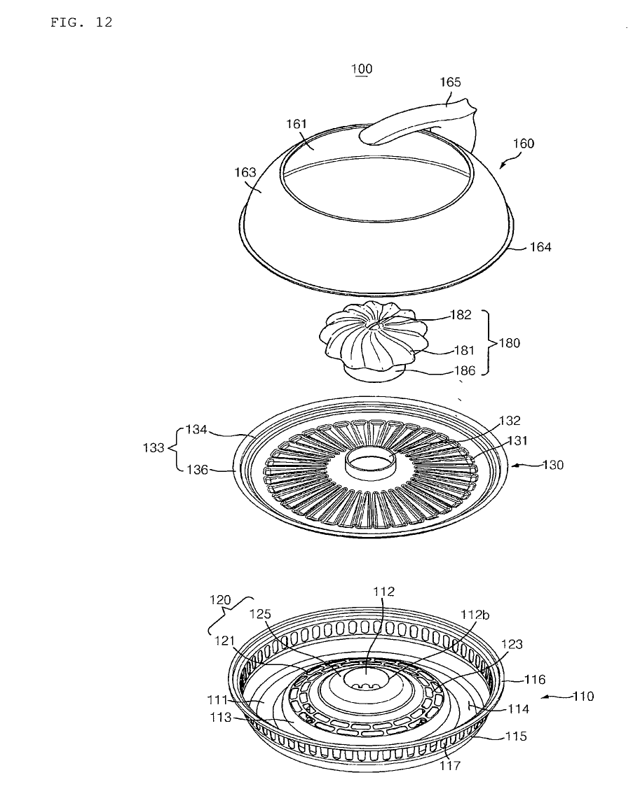

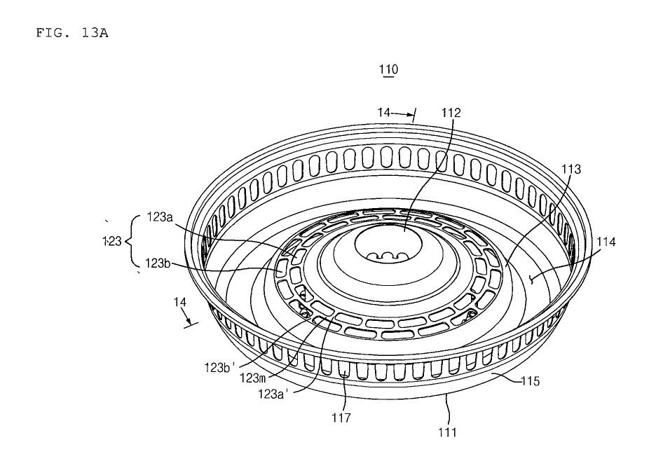

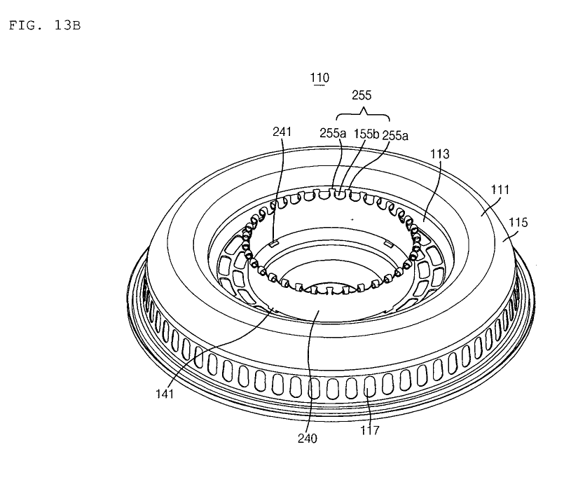

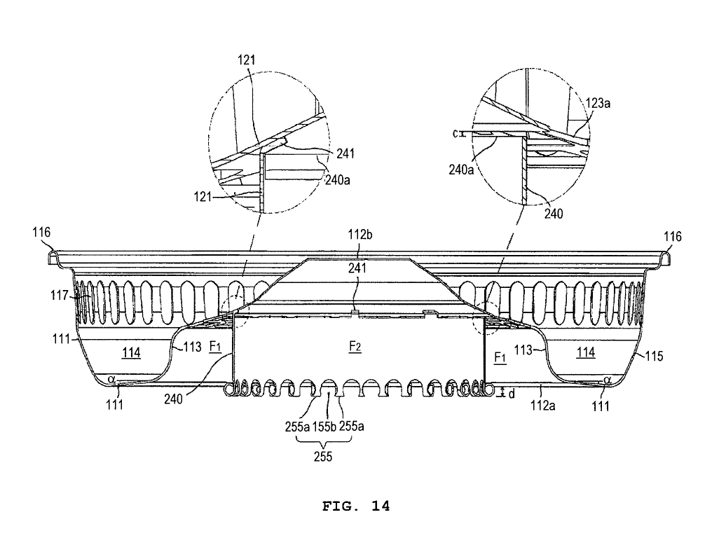

FIGS. 12-16 illustrate another exemplary embodiment of the direct-broiling cooker according to the present disclosure. In this exemplary embodiment, the subsidiary flame guide holes 123 can comprise two rows of holes formed along the first heat guide 121 (as shown in FIG. 13A). The first row of subsidiary flame guide holes 123a and the second row of subsidiary flame guide holes 123b can be arranged in, e.g., a zigzag arrangement.

This, the two rows of subsidiary flame guide holes 123a, 123b can function to suppress heat transfer when heat of the second heat guide 125 heated by flames is transferred to the inner wall 113 through the first heat guide 121.

As shown in FIG. 13A, the first heat guide 121 can comprise first radial heat transfer ribs 123a′ formed between the first row of subsidiary flame guide holes 123a, second radial heat transfer ribs 123b′ formed between the second row of subsidiary flame guide holes 123b, and circumferential heat transfer ribs 123m formed between the first row of subsidiary flame guide holes 123a and the second row of subsidiary flame guide holes 123b. Therefore, heat of the second heat guide 125 can be sequentially transferred through the first radial heat transfer ribs 123a′, the circumferential heat transfer ribs 123m and the second radial heat transfer ribs 123b′, so that the heat transfer is retarded and the heat comes into contact with air while being transferred. Thus, during the heat transfer, the temperature of heat becomes reduced, and the heat transfer to the drip channel 114 may not be realized.

Further, the gap C can be determined to be equal to or less than about 10 mm. When no gap is defined between the upper end of the flame guide 140 and the first heat guide 121, it is possible to completely intercept the flames. However, in the above exemplary case, the flames can be shielded from air, so that a sufficient amount of oxygen is not supplied to the flames and incompletely combusted flames are led into the body 110, and heat circulation efficiency can become reduced. When the gap C exceeds about 10 mm, excessive flames can flow back to the first heat path F1, and heat the drip channel 114 so that the body 110 would likely not be used without water being contained in the drip channel 114.

The gap C may be formed by spacers 241 installed between an upper end 240a of a flame guide 240 and the inner wall 113 at angular intervals of about 90 degrees or about 120 degrees through welding. Thus, the gap C can be defined in a state in which the flame guide 240 is installed in the body 100. Further, the upper end 240a of the flame guide 240 can be arranged around the junction between the first heat guide 121 and the second heat guide 125 such that the upper end 240a of the flame guide 240 does not obstruct the subsidiary flame guide holes 123. Further, the lower end 240b of the flame guide can include an antislip part 255. The antislip part 255 can be provided on support legs 1 of the burner 100, thus preventing the body 110 from slipping over the burner 100.

The antislip part 255 can comprise saw-toothed antislip protrusions 255a and antislip notches 155b defined between the antislip protrusions 255a and engaging with the support legs 1 of a burner. When the antislip notches 155b stably engage with the support legs 1, the body 110 can be prevented from slipping over the burner 100. The lower end 240b of the flame guide 240 or the antislip part 255 is placed at a location lower than the bottom portion 111 by a height d, so that, when the body 110 is provided on a support surface, the antislip part 255 can be prevented from scratching the support surface. Further, the antislip part 255 can be curled at the ends of the saw-toothed antislip protrusions 255a, so that even when the antislip part 255 is undesirably pressed downwards, the saw-toothed antislip protrusions 255a can resist deformation.

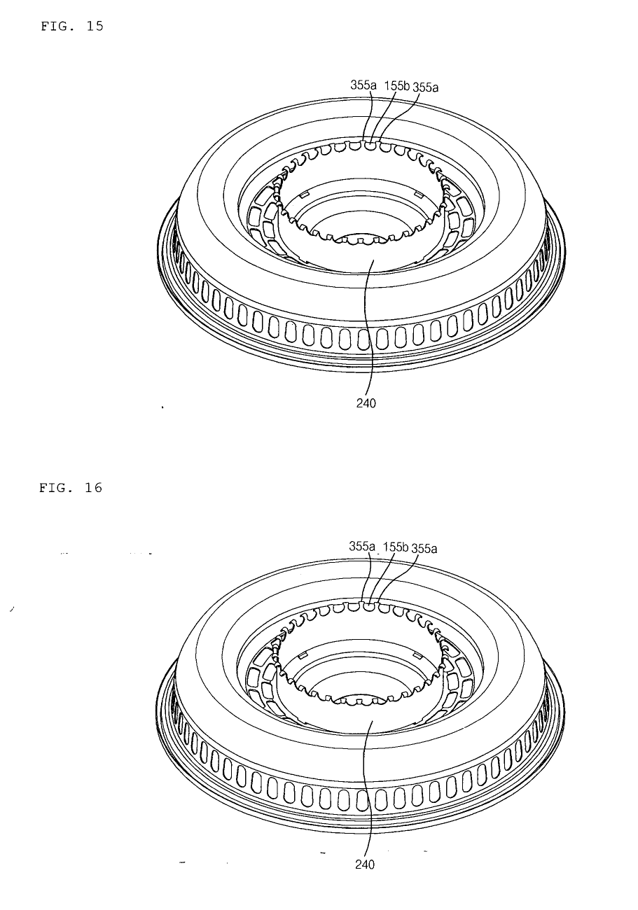

When the ends of the antislip protrusions 255a are completely curled to form a ring shape as shown in FIG. 13B, it is possible to remove sharp ends and to realize increased strength of the ends. However, when the ends of the antislip protrusions 355a are half curled as shown in FIG. 15, the antislip protrusions 355a realize a strength lower than that of the antislip protrusions 255a shown in FIG. 13B. FIG. 16 shows antislip protrusions 455a subjected to no curling.

The foregoing merely illustrates the principles of present disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of present disclosure and are thus within the spirit and scope of the present disclosure. In addition, to the extent that the prior art knowledge has not been explicitly incorporated by reference herein above, it is explicitly being incorporated herein in its entirety. All publications referenced herein above are incorporated herein by reference in their entireties.

What is claimed is:

1. A body arrangement for at least one direct-broiling cooker, comprising:
an inner wall including a flame guide opening therein;
an outer wall surrounding the inner wall;
a bottom portion extending between the inner wall and the outer wall and forming a drip channel; and
a flame guide arrangement provided between the inner wall and the flame guide opening, wherein, in operation, air is guided between the inner wall and the flame guide, and flames are guided to a center portion of the flame guide arrangement.

2. The body arrangement according to claim 1, wherein the bottom portion includes an inclined bottom section which is inclined downwards in a direction extending from the inner wall to the outer wall.

3. The body arrangement according to claim 1, wherein the flame guide is mounted to a safety stand frame which is removably provided in an inlet of the flame guide opening.

4. The body arrangement according to claim 3, wherein the safety stand frame comprises (i) a hollow base plate maintaining the flame guide, (ii) an antislip part provided in a lower surface of the base plate, and (iii) inner fitting pieces provided on the base plate and fitted into the flame guide opening so as to support the inner wall.

5. The body arrangement according to claim 1, wherein the inner wall includes at least two rows of subsidiary flame guide holes, wherein a first row of the subsidiary flame guide holes and a second row of the subsidiary flame guide holes are arranged in a zigzag pattern.

6. The body arrangement according to claim 1, wherein the flame guide arrangement is supported at an upper end thereof by the inner wall, and is includes, at a lower end thereof, an antislip part provided at a location lower than a lower surface of the bottom portion.
